(19) United States
(12) Patent Application Publication
(10) Pub. No.: US 2001/0002982 A1
(43) Pub. Date: Jun. 7, 2001

(54) Lead-free, high tin ternary solder alloy of tin, silver, and bismuth

(76) Inventors: Amit Kumar Sarkhel, Endicott, NY (US); Charles G. Woychik, Vestal, NY (US)

Correspondence Address: Lawrence R. Fraley, IBM Corporation, N50/040-4, 1701 North Street, Endicott, NY, 13760, US

(21) Appl. No.: 09/771,240

(22) Filed: Jan. 26, 2001

Related U.S. Application Data
(62) Division of application No. 09/216,042, filed on Dec. 18, 1998.
Application No. 09/216,042 is a continuation-in-part of application No. 08/768,878, filed on Dec. 17, 1996, now abandoned.
(60) Provisional application No. 60/019,591, filed on Jun. 12, 1996.

(51) Int. Cl. C22C 1/00; B23K 31/02

(52) U.S. Cl. 420/590; 228/178

(57) ABSTRACT

A high strength ternary lead-free solder alloy, solder paste and method. The alloy consists essentially of a major portion of tin, from in excess of 5 wt % bismuth to 25 wt % bismuth and 2 to 5 wt % silver.

### FIELD OF THE INVENTION

The present invention is a continuation-in-part of U.S. patent application Ser. No. 08/768,878 filed Dec. 17, 1996 and relates to a high strength, lead-free, low toxicity, ternary solder alloy that is particularly useful in microelectronic applications.

### BACKGROUND OF THE INVENTION

Solders are used in low temperature, usually reversible, metallurgical joining processes. Low temperature solders with reversibility are especially important in electronic applications. The low temperature is required since many materials are damaged by even moderately high temperatures. The reversibility is required since reworking of products is often necessary. Low temperature soldering is extremely well suited for this.

Solder joining is a wetting process followed by a chemical reaction. Molten solder wets the substrate selectively. The selective wetability of solder allows molten solder to be confined to metallic pads and not to solder mask materials. This is especially important in flip chip bonding and surface mount attachment of components such as quad flat packs, and ball grid array modules.

The soldering process takes place virtually as quickly as the wetting process once the solder has melted. For example, with rapid heating, soldering can take place in just a few seconds. This makes soldering particularly desirable for automated, high-speed, high through-put processes.

Wetability is not only a function of the solder material, but is also a function of the materials to be joined by the solder, such as copper, nickel, gold and palladium, as well as those rich in one or more of these metals which are particularly amenable to soldering.

Chemical reaction following wetting occurs between the liquid solder and the materials being joined, which forms intermetallic phases at the interfaces. The intermetallic phases formed by solders in electronic packaging are stoichiometric compounds, typically binary compounds and typically containing tin if tin is present in the solder alloy. If one of the metals to be joined is copper and the solder alloy contains tin, the intermetallic compound formed during soldering is Cu-Sn. Cu-Sn binaries include CU3 Sn and CU6Sn., although other intermetallics may be formed.

Solder alloys are characterized by the melting temperature being a function of composition. Thus, while a pure metal is characterized by a single invariant melting temperature, the freezing and melting points of alloys are complex. The freezing point of an alloy is determined by the liquidus line, wherein only a liquid phase exists above the liquidus line. The melting point of an alloy is determined by the solidus line, wherein only a solid phase or phases can exist below the solidus line. In the region between the solidus and liquidus lines, solid and liquid phases generally co-exist. Many soldering alloys are eutectic; i.e., they are characterized by a eutectic point. The eutectic point is where the liquidus and solidus lines meet, and thus there is a single melting temperature representing both the liquidus and solidus temperature. A change in concentration of the element in either direction from the eutectic composition results in an increase in the liquidus temperature, and also generally in a separation between the liquidus and solidus lines, with liquid and solid phases therebetween as indicated above. The composition and quench rate also determine the microstructure and resulting mechanical properties of a solder joint. Thus, it is necessary to both carefully choose the solder composition and to control the thermal exposure and thermal excursions of the solder joint.

One very common type of solder composition used in electronics fabrication is the tin/lead alloys. These alloys are capable of forming electrically-conductive, thermally stable, non-brittle intermetallics with the material being joined. One particular alloy that is well known is a eutectic tin/lead composition which contains about 63% tin and 37% lead. This particular alloy, being a eutectic, has a melting point of 183° C. (compared to Sn which has a melting point of 232° C. and Pb which has a melting point of 327° C.). This low melting point, plus the workability of the lead/tin alloys and the adhesion of the copper/tin intermetallics over a wide temperature range, and the availability of equipment and related materials for the process has made the tin/lead alloys extremely desirable. This relatively low temperature in non-damaging to most electronic components and other materials such as organic substrates, and the process is reversible.

Another important characteristic of this material is the softness or plasticity of these lead-base solders. This softness or plasticity allows the solder to accommodate the mismatch in coefficients of thermal expansion of bonded structures. For example, the mismatch in coefficients of thermal expansion between a ceramic dielectric and a polymeric dielectric, or between a semiconductor chip and a ceramic or polymeric chip carrier or substrate, can readily be accommodated.

However, one major drawback to the fin/lead alloys is that lead is toxic and has a relatively high vapor pressure. Thus, while in many cases there 4 not a large amount of lead present, nevertheless the accumulation of lead, even in small amounts, can be unacceptable and thus the use of lead is becoming more and more disfavored, with a replacement for the lead being required.

U.S. Pat. Nos. 4,998,342 and 4,761,881 suggest pin-in-hole and surface mount assemblies using wave soldering and solder paste. The disclosure of each of these patents are incorporated herein by reference.

U.S. Pat. No. 5,328,660 to Gonya et al relates to a solder alloy containing Bismuth,, Silver, Tin and Indium, and more specifically to a quaternary solder alloy of 78% Sn, 2% Ag, 9.8% Bi, and 9.8% In, which is distinct from the present invention.

U.S. Pat. No. 5,439,639 to Vianco et al relates to ternary Sn-Ag-Bi solder alloys containing high percentages of Sn, namely about 91.0% to 96.0% Sn, plus 3.2-3.5% Ag, and 3.0-4.83% Bi. Vianco et al specifies that the ratio of Ag to Sn be 0.036, the same ratio as in the binary Sn-Ag eutectic alloy (the ratio of 3.5% Ag and 96.5% Sn in the binary alloy is 0.036). Vianco et al further specifies that the Bi percentage in their ternary solder be limited to 4.83% so that Bi is held in solid solution with Sn at room temperature. One drawback of these solder compositions is that the Bi content is quite low and the melting point is not lowered sufficiently.

U.S. Pat. No. 4,211,822 to Kurfman et al relates to fabricating metal/polymer reflective composite substrates, where metal member of the duplex structure is a soft metal or alloy containing 50% of one or more among Antimony, Indium, Bismuth, Tin, Zinc, Cadmium and Lead; 0-10% of one or more metals among Manganese, Nickel, Iron; and the remaining percentage consisting of one or more among Silver, Copper, Gold, Aluminum and Magnesium. Among many exemplary alloys described, two are: 55% Sn/10% Ag/35% Bi and 75% Sn/5% Ag/20% Bi. The alloys described by Kurfman et al are meant for a unique metal/composite application and do not possess the desirable properties required of solder joining of electronic packages. Furthermore, the Sn-Ag-Bi compositions of Kurfman et al are distinct from the solder compositions of the present invention.

### SUMMARY OF THE INVENTION

A ternary Lead-free solder has been discovered in accordance with the present invention that wets and forms a chemically and thermally stable bond with bonding pads typically used in electronics fabrication and which has properties close to tin/lead alloys particularly an alloy of 63% tin and 37% lead. The ternary lead-free solder of the present invention consists essentially of tin, silver and bismuth with a major proportion of tin and minor proportions of bismuth and silver resulting in enhanced solder flow characteristics, ductility and low melting temperature so as to prevent damage to electronic materials.

The subject invention is directed, in one embodiment, to a ternary solder alloy which is lead free, of high strength and particularly well suited for microelectronic applications with the ternary solder alloy consisting essentially of a major proportion of Sn and lesser concentrations of Bi and Ag. For purposes of the present invention, major proportion of Sn means from about 70 weight percent Sn to less than 91 weight percent Sn with the balance Bi and Ag.

The subject invention is further directed to a solder paste comprising a flux, an organic vehicle and particles of metal in a composition consisting essentially of a major proportion of tin by weight, balance bismuth and silver.

The subject invention is further directed to a method of joining microelectronic components with a ternary solder alloy consisting essentially of a major proportion of tin, between about 5 to 25% bismuth and 2 to 5% silver.

An even further embodiment of the present invention is directed to a process for producing circuit boards comprising: producing plated through hues in a decreet board; inserting the pins of pin-in-hold components into the plated through holes; producing a stationary wave of liquid solder consisting essentially of a major proportion of tin by weight, between about 5 to 25% bismuth and 2 to 5% silver; moving the circuit board across the wave with a bottom of the circuit board in contact with the wave, thereby substantially filling the plated through holes with solder; and cooling the circuit board to form solid solder joints.

In addition the subject invention includes a process for producing circuit boards comprising the steps of: producing substrates with multiple wiring layers including exposed metal pads on a surface; forming a solder paste composing a flux, an organic vehicle and particles of metal consisting essentially of a major proportion of tin by weight, between about 5 to 25% bismuth and 2 to 5% silver; depositing the solder paste upon said substrate; placing terminals of a surface mount component onto corresponding pads of the substrate; heating said solder paste to a temperature sufficient to reflow the solder paste to connect the component with the substrate; and cooling to solidify the connections.

### DESCRIPTION OF THE DRAWINGS

The accompanying figures which are part of the specification further illustrate the present invention and, together with the description, serve to explain the principles of the invention.

FIG. 1 shows the Sn-Bi phase diagram;

FIG. 2 shows the Sn-Ag phase diagram;

FIG. 3 shows the Ag-Bi phase diagram;

FIG. 4 shows a predicated approximation of the Liquidus Surface for the ternary Sn-Ag-Bi system having an exemplary alloy composition circumscribed by the area SPQR;

FIG. 5 is an expanded version of the diagram of FIG. 4 showing the area defining the alloy composition of the present invention;

FIG. 6 shows a Differential Scanning Calorimeter (DSC) plot for Alloy 4;

FIG. 7 shows a DSC plat for Alloy 5;

FIG. 8 shows a DEC plot for Alloy 6;

FIG. 9 shows a DSC plot for Alloy 7;

FIG. 10 is a schematic drawing showing the joining by “flip chip” bonding of an integrated circuit chip to a substrate using a ternary solder alloy or paste according to this invention;

FIG. 11 is a schematic of a circuit board showing surface mount components attached to a circuit board by the reflowing solder paste; and

FIG. 12 is a schematic of a circuit board showing pin-in-hold components attached by wave soldering.

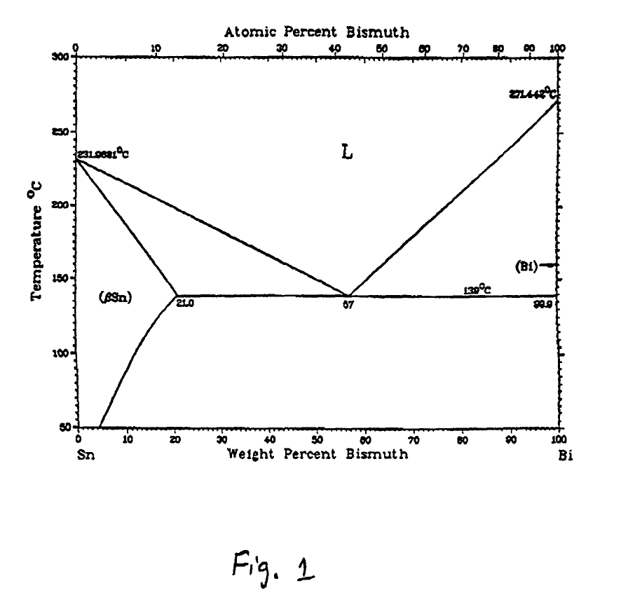

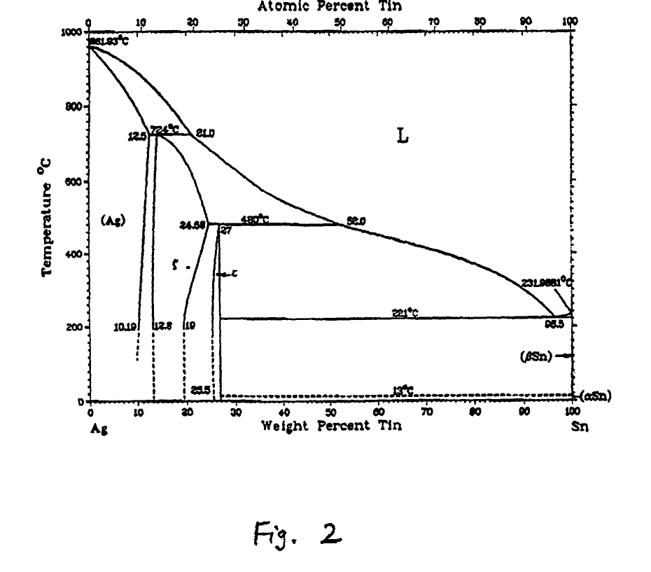

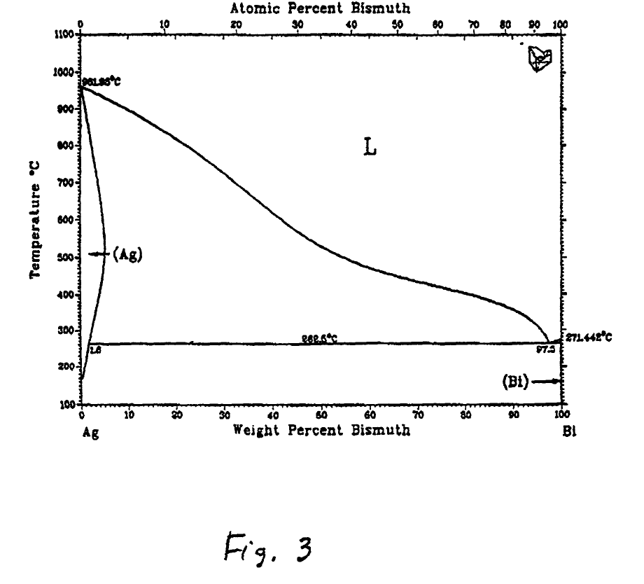

### DETAILED DESCRIPTION OF THE INVENTION

A load-free, high strength, ternary solder alloy or paste is formed in accordance with the teaching of the present invention containing metal particles consisting essentially of a major proportion by weight of tin balance bismuth and silver.

It is advantageous for a solder alloy to have a eutectic composition, or a composition that is close to the eutectic point. For example, the most commonly used Sn/Pb solders include the eutectic composition 63 Sn/37 Pb (which melts at a single temperature, 183° C. and near-eutectic composition, 60 Sn/40 Pb (which melts over a range of temperature, 183-188° C.).

The binary phase diagrams of the systems Sn/Bi, Sn/Ag and Ag/Bi are well known and have been documented in reference works, for example, Binary Phase diagrams (vol. 1 and 2) T. B. Massalski, Editor-in-Chief, American Society for Metals, Metals Park, Ohio.

Eutectic or near-eutectic solder compositions offer several advantages. First, they solidify or freeze from the liquid state to the solid state at a single temperature or within a narrow range of temperatures. Second, the resulting micro-structure in the solid state consists of an intimate mixture of phases. This type of micro-structure produces the optimum combination of ductility and strength. Ductility is a very desirable property of solder alloys for the purpose of arresting crack propagation and for enhanced resistance to thermal fatigue. An alloy whose composition is exactly the eutectic composition, for example 63 Sn/37 Pb, will produce a microstructure upon freezing and consists entirely of a duplex mixture of Sn-rich and Pb-rich phases. A near-eutectic composition, for example 60 Sn/40 Pb, at the onset of freezing will precipitate a Pb-rich phase, thus depleting the liquid of Pb and increasing the relative concentration of Sn. Eventually, the liquid will reach the 63 Sn/37 Pb eutectic composition and then will freeze all at once. This liquid is known as the Last Solidifying Liquid (LSL). The ultimate microstructure of the 60 Sn/40 Pb alloy will consist of a minor portion of isolated Pb grains and a major portion of intimately intertwined Sn and Pb grains, the latter being the eutectic microstruture.

In accordance with the commonly known principles or phases rules of binary and ternary metallic systems, a binary eutectic alloy upon solidification forms an intimate mixture of two phases, whereas a ternary autectic alloy forms an intimate mixture of three phases.

In our efforts to develop a lead (Pb)-free, high strength, high ductility, Sn-rich compositions, we chose the metallic elements Sn, Ag and Bi, based on the fact that one or more of these elements, as well as others, are commonly used in solders, and the fact that the individual binary phase diagrams of the pairs of Sn/Bi, Sn/Ag, Ag/Bi are known. The Sn/Bi system has a eutectic composition at 42 Sn/58 Bi (melting point 138 C.). The Sn/Ag system has a eutectic composition at 96.5 Sn/3.5 Ag (melting point 221 C.). The Ag/Bi system has a eutectic composition at 2.6 Ag/97.4 Bi (melting point 262.5 C.).

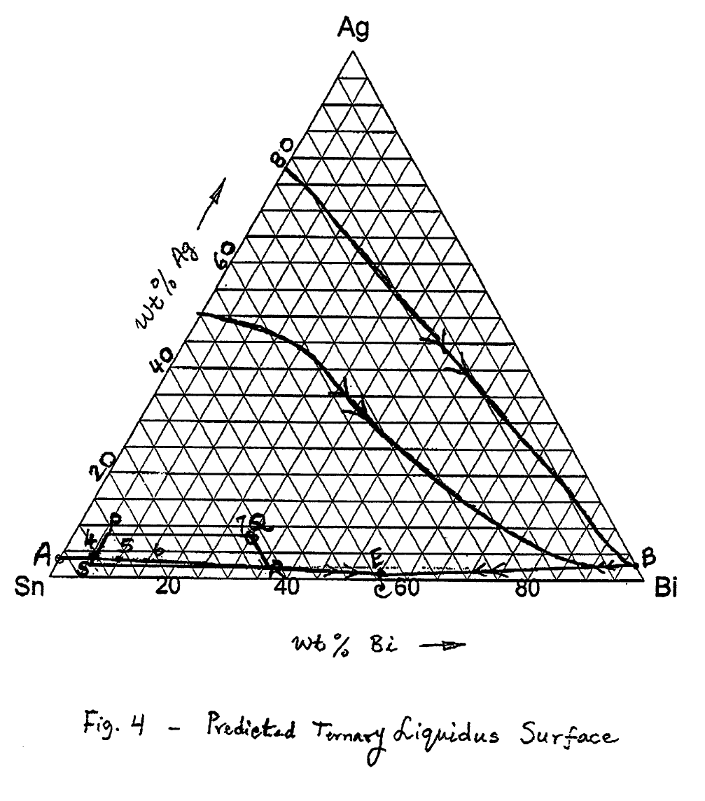

In a soft and low-melting point solder, Sn is necessary for metallic bonding to the substrate to be soldered. Ag is a constituent used for strength and other desirable properties in many solders such as 96.5 Sn/3.5 Ag and 62 Sn/36 Pb/2 Ag (however, the latter solder contains Pb which we want to avoid). Bi is a constituent of several solders, most notably 42 Sn/58 Bi, which is a binary eutectic solder with a melting point of 138 degree C. The addition of Bi to any Sn-based solder tends to lower the melting point because of the Sn-Bi binary eutectic has such a low melting point (138 C.). Eutectic points in the ternary phase diagram create the best solders from the standpoints of microstucture, mechanical properties and melting point, just as do in binary systems. However, the ternary phase diagram of the Sn-Ag-Bi system is not known with certainty. By applying the principles of ternary phase diagram construction, an approximate ternary liquid surface is predicted (FIG. 4). The diagram shows approximately where a eutectic composition is likely to lie, namely at point E, where the composition roughly is 43% Sn/56% Bi/1% Ag (all compositions herein are in weight percentages). Furthermore, the diagram in FIG. 4 shows several curved lines marked with double arrows, these lines are the predicted Pseudo-Binary Grooves. The predicted eutectic point E is a point where three pseudo-binary grooves AE, BE and CE intersect.

The points A, B and C represent the compositions 96.5 Sn/3.5 Ag, 97.5 Bi/2.5 Ag and 43 Sn/57 Bi respectively, and simply are the binary eutectic points from the binary phase diagrams. The prediction of the location of point E was based on experimental studies of solidification microstucture of prepared alloys, particularly that of Alloy 7, as will be explained shortly. The predicted ternary eutectic alloy E (43% Sn/56% Bi/1% Ag) itself, although it is likely to have the desirable, intertwined, eutectic microstucture, it is not an ideal solder. The high Bi content (over 40%) most likely will make the alloy brittle.

Alloy compositions lying on the pseudo-binary groove AE, but containing lower than 40% Bi, or preferably lower than 30% Bi, were considered more promising. For this reason, alloys containing in excess of 30% Bi were excluded from consideration at the outset. Alloys at the other end of the line AE, those lying very close to the Sn/Ag side of the ternary triangle, that is, in the vicinity of point A, were also excluded. Such alloys essentially have from 0% to under 5% Bi. These alloys would not result in sufficient lowering of the melting point from 221 C. (the melting point of the binary 96.5 Sn/3.5 Ag/0.0 Bi alloy). Since one of the main purposes of adding Bi to binary alloys of Sn and Ag, is to lower the melting point and bring it closer to the melting point (183 C.) of the standard 63 Sn/37 Pb solder, that purpose will be defeated.

With this in mind, several alloys were prepared for investigation. Among these, Alloy 7 is a high Bi content alloy of composition 63.2% Sn/30% B I/6.8% Ag that was expected to contain a high enough portion of ternary eutectic in its microstucture and thus easiest to study. Its microstucture was analyzed carefully with metallographically prepared samples. When a liquid alloy is cooled, the last solidifying liquid (LSL) produces islands of eutectic microstucture, where three phases are intimately mixed and can be observed at high magnification in a sample. The intimately mixed, euetectic portion of the microstructure of Alloy 7 showed three phases, a Sn-rich phase, a Bi-rich phase and a Ag-containing phase that had the appearance and characteristics of Ag3Sn, a phase that is well known in the literature of binary Sn-Ag alloys and phase diagrams. Subsequently, by estimating the volume fraction of the various phases in the microstucture, together with known densities of the elements, a rough estimate of the ternary eutectic composition was made, which gave the location of point E. Thus, lines AE, BE, CE could now be drawn. The other alloys prepared include Alloy 4, 5 and 6. Their compositions lie on AE. As mentioned previously, there is uncertainty about the exact location of the pseudo-binary groove AE because the above method employed is not very accurate. To allow for the uncertainty and possible deviation in the exact location of this line, an area on the ternary diagram was selected for melting point investigation rather than just the line AE. This area is denoted by PQRS. Alloys 4,5,6,7 lie within PQRS. The bounds of PQRS were chosen with the rationale that the desired alloys should have a Bi content exceeding about 5-6% (for sufficiently low melting point) but less than 30-35% (so that the alloys are not too brittle) and the Ag content be about 2-7% (so that the resulting compositions do not stray too far away from line AE), and balance Sn. The aforementioned Ag bounds are represented approximately by the lines PQ an SR, and the Bi bounds by SP and QR. The area PQRS was of interest initially.

Melting Point Determination of Exemplary Alloys

Alloys 4, 5, 6, 7 lie within the rectangle or on the sides of the rectangle. The melting points of these alloys were determined by Differential Scanning Calorimetry by heating small amounts of prepared alloys at a rate of 5 degree Celsius per minute.

### Alloy 4

Alloy 4 of composition 90.8 Sn/6.1 Bi/3.1 Ag was determined to be 210 degree C., as shown in FIG. 6.

### Alloy 5

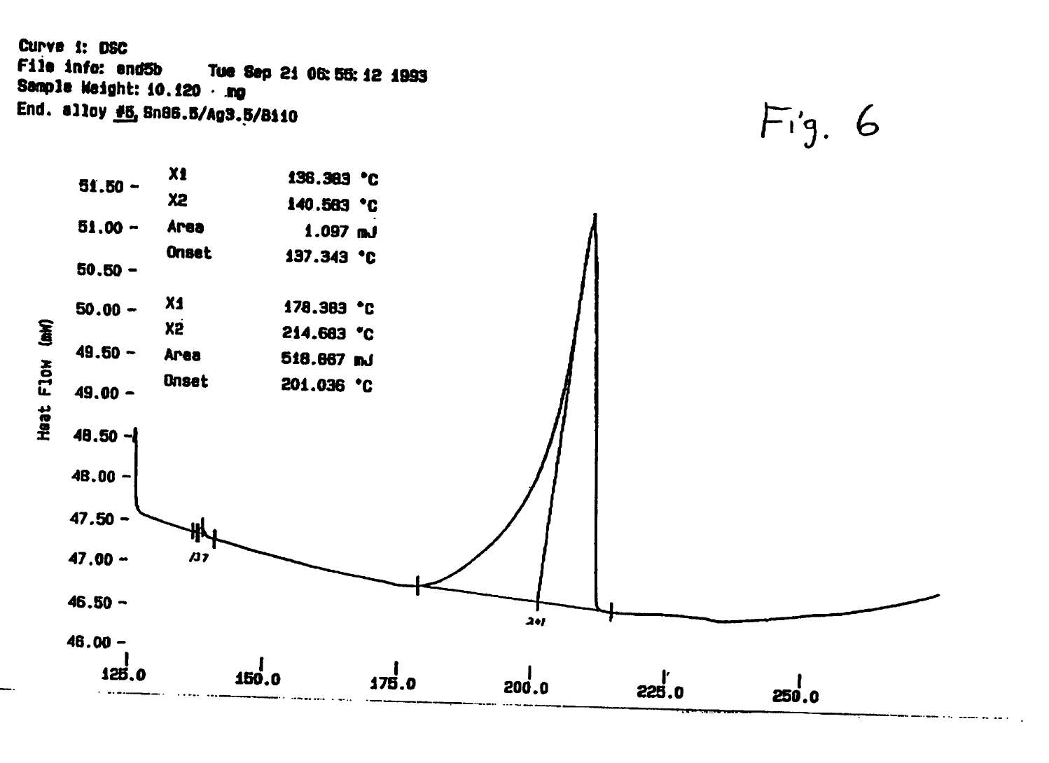

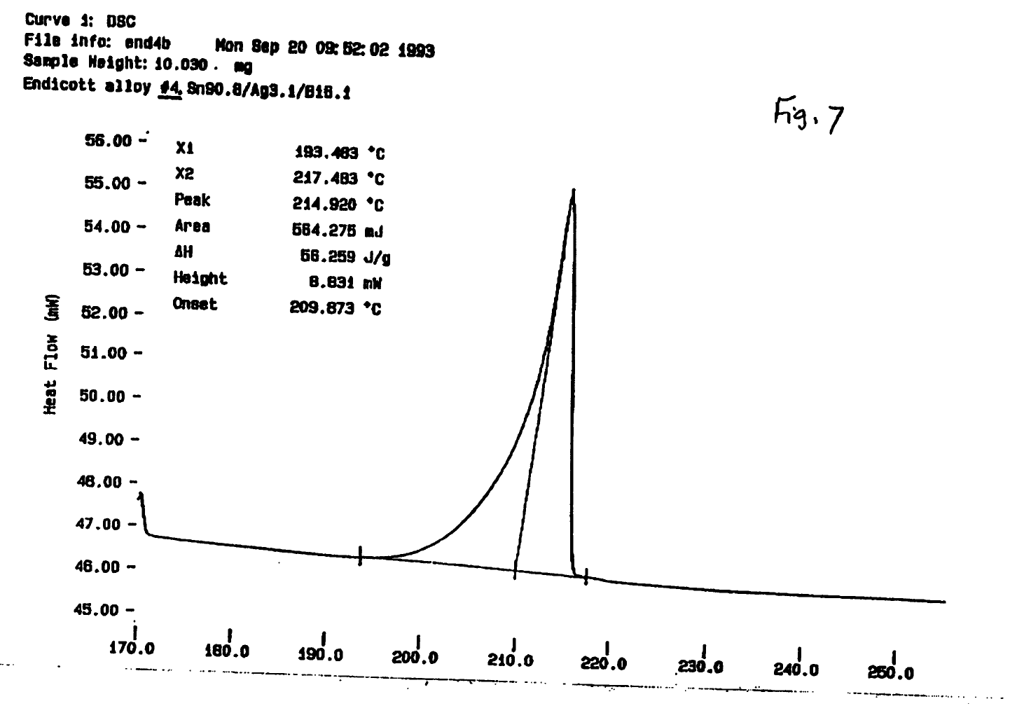

Alloy 5 of composition 86.5 Sn/10.0 Bi/3.5 Ag lies inside the rectangle PQRS. Its melting point was determined to be 201 degree C., as shown in FIG. 7. There is also a very small peak at 137 degree C., indicating a few Sn-rich grains and Bi-rich grains, in close proximity to each other, behaving as Sn-Bi binary eutectic whose melting point is about 137° C. However, a very small volume fraction of the alloy showing an incipient tendency to remain in the liquid state down to 137 degree C. does not affect soldering processes. Furthermore, since the service temperature of filtered electronic equipment is rarely above about 80 degree C., this phenomenon will not detract from using this solder.

### Alloy 6

Alloy 6 of composition 81.7 Sn/15 Bi/3.3 Ag lies well inside the rectangle PQRS. Its melting point was determined to be 191 degree C. (FIG. 8). There is a secondary small peak at 137 degree C.

### Alloy 7

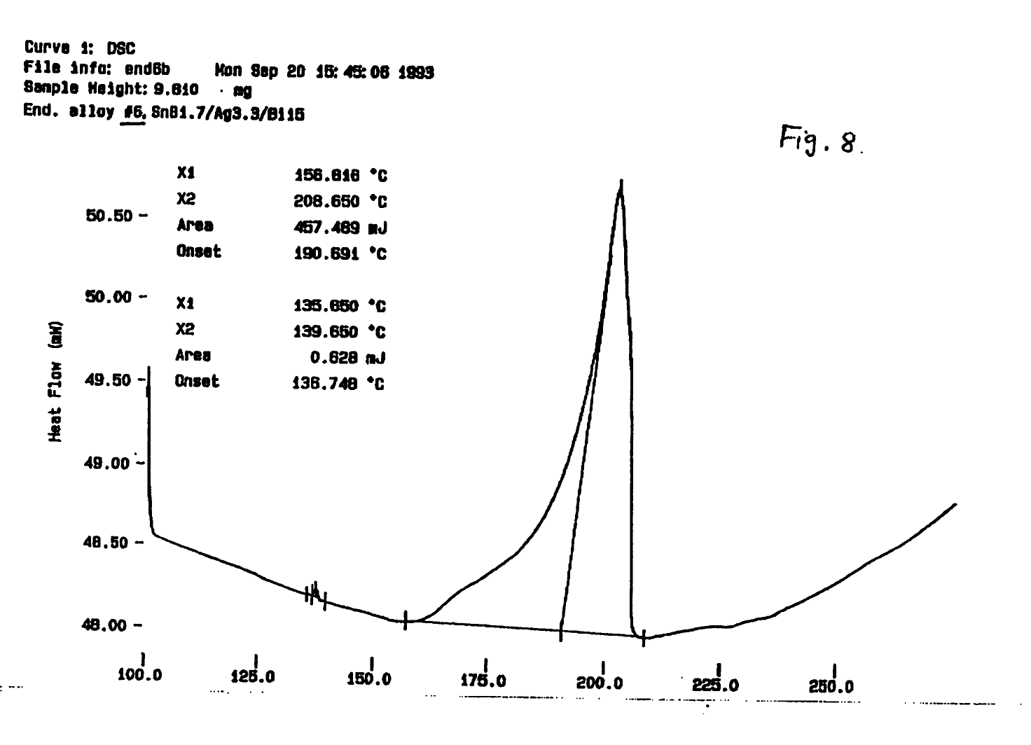

Alloy 7 of composition 63.2 Sn/30.0 Bi/6.8 Ag lies at point Q of the rectangle. Its primary melting point was determined to be 137 degree C. (FIG. 9) and a secondary melting point at 181 degree C. This is clearly a very low melting point alloy similar to the binary Sn/Bi eutectic in regard to melting point. Therefore, the percentage of Bi should be reduced and that of Sn increased. Bi should be decreased to 25%, Sn increased to at least 70%, balance Ag.

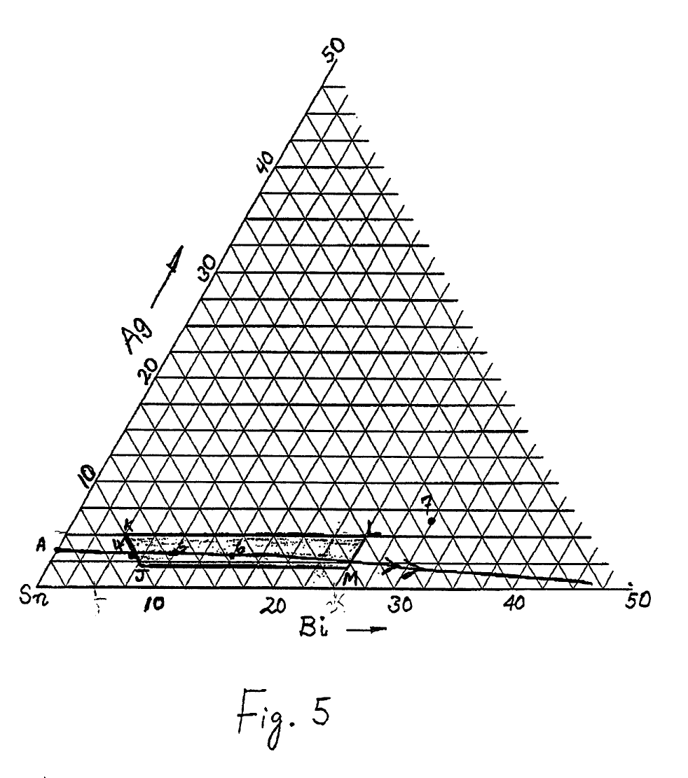

Based on the above-described application of ternary phase diagram, alloy preparation and melting point determination, a region of alloy compositions has been discovered. The region is marked as the shaded rectangle JKLM in FIG. 5. The inventive alloys lie within this rectangle but not on its sides. The alloys have compositions that include Sn from about 70% to less than 91%; Ag from about 2% to less than 5%; and Bi exceeding 5% with a maximum of up to 25%. The preferred alloys are exemplified by Alloy 5 (86.5Sn/10.0 Bi/3.5 Ag) and Alloy 6 (81.7 S.n./15 Bi/3.3 Ag) which have melting points in the range of 190-200° C., which is close to the melting point of the standard 63Sn/37 Pb eutectic solder.

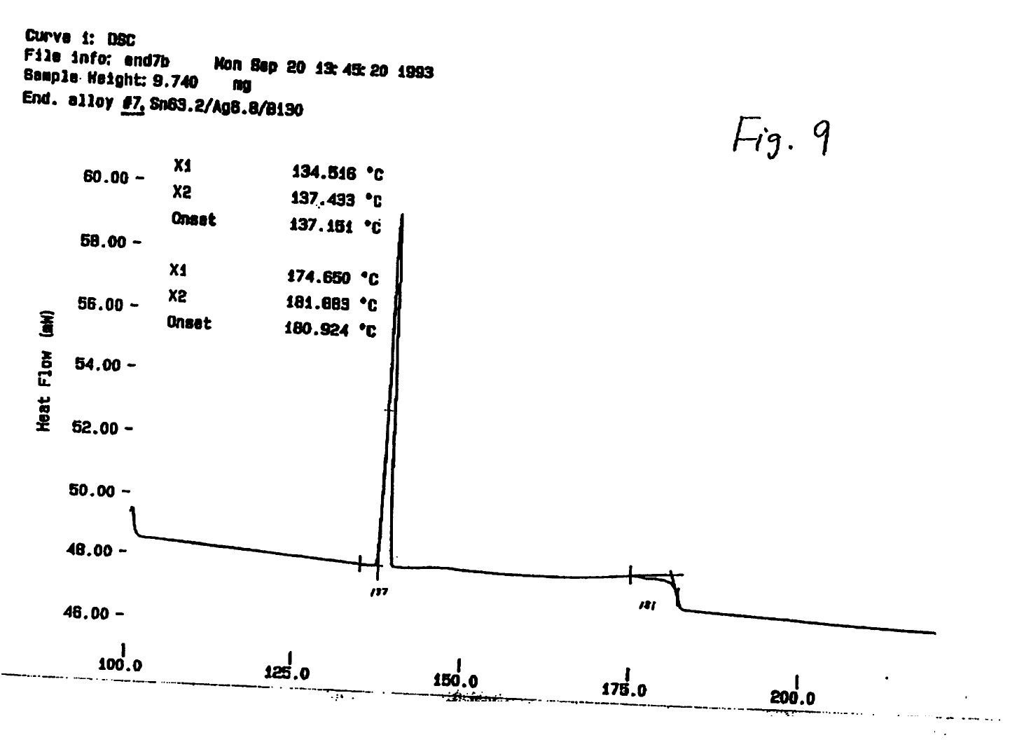

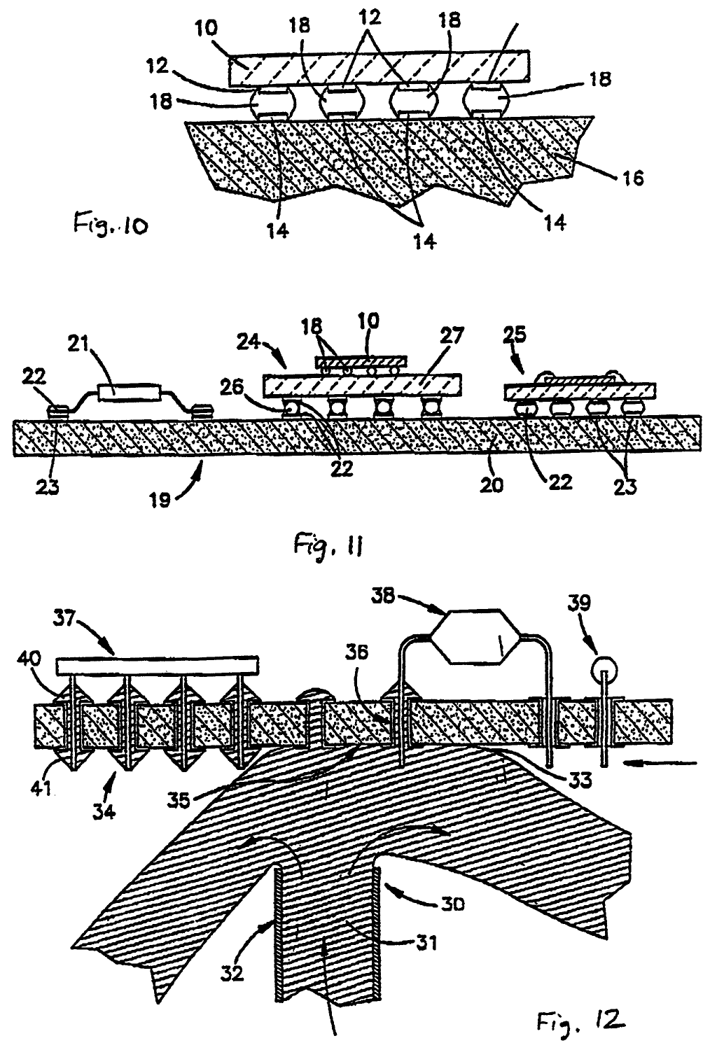

The solders of the present invention can be used in the same manner as the tin/lead solder is currently used in microelectronic applications. FIG. 10 shows the solder of the present invention used for “flip chip bonding”. An IC chip 10 having contact pads 12 thereon is shown bonded to bonding pads 14 on a dielectric substrate 16 by solder connection 18. The substrate can be a chip carrier or a planar board, and these substrates can be formed of ceramic or organic materials such as glass filled epoxies or polyimides or flexible laminates of patterned copper foil and dielectric polymeric films. The solder alloy is deposited on the pads 12 and/or 14, the chip is placed on the carrier, and the solder is melted to form the connections, and then cooled to solidify.

During reflow, the assembly is heated to cause the solder alloy to wet and bond to the electrical contacts of the circultized substrate. Heating may be by vapor phase reflow, laser reflow, oven melting, or by any other suitable means of heating to above the liquidus temperature. Other types of connections can be made between various components In microelectronics.

The resulting microelectric circuit package of the invention in FIG. 10 is an integrated circuit chip module with a circuitized chip carrier, i.e., a substrate, a semiconductor integrated circuit chip, and a tin/silver/bismuth alloy solder bond electrically interconnected between the circuitized chip carrier and the semiconductor integrated circuit chip.

Moreover the process is reversible In that to “desolder”, the soldered board is heated to above the liquidus temperature, and the soldered components separated. This allows for replacement of any defective parts or connections.

FIG. 11 shows a circuit board assembly 19 embodiment of the invention which includes a card 20 which may be any known printed circuit board substrate, and surface mount components such as a gull-wing or J-leaded component 21 which may be a quad flat pack, dual in-line package, small outline integrated circuit package or other well known surface mount component. The component 21 is attached by applying, preferably by screening, solder paste on copper pads 23, placing the leads of the component on the pads and reflowing the solder in an oven at a reflow temperature 20-30° above the liquidus temperature.

The solder paste is composed of a flux material and a vehicle comprised of various organic materials to control the properties such an the rheology of the paste with the solder particles dispersed therein. The flux and organic vehicles are selected for various different applications as Is well known in the art. Typically, metal solder particles will constitute about 90% by weight of the solder paste.

The solder paste reflows to produce a solder joint 22 of an alloy containing S.n., Ag, and Bi, with preferably 5-25 wt % Bi , 2-5 wt %, Ag balance tin.

In a similar manner, ball grid array modules 24 and 25 of the invention may be attached to the card by applying, preferably by screening, solder paste of the invention onto metal pads or onto the balls, placing the module with balls on the pads and reflowing. Chip carrier 24 Includes spherical preforms or balls 76 with solidus temperature significantly above the reflow temperature of the solder paste. The balls may be pre-attached to the underside of the chip carrier substrate 27 by welding or more preferably by using the solder of the present invention. The flip chip on the top of the module 24 may be connected as previously described with reference to FIG. 10. Module 25 of FIG. 11 may include solder bumps of the solder of the invention and/or paste of the invention may be screened on an array of pads 23 and connected by reflowing as described above to form the solder joints 22.

FIG. 12 shows a wave solder machine 30 where molten solder 31 of the invention Is pumped up through nozzle 32 to form an elongate wave 33 across which a circuit board assembly 34 is moved. The wave contacts across the bottom surface 35 of the assembly and the solder flows into holes 36 which are plated with metal such as copper to which the solder wets in order to provide capillary action which draws the solder up into the holes. The pins of pin-in-hole components such as pin grid array chip carrier 37 and dual in-line package 38 and discrete components 39 such as resistor and capacitors, are Inserted into the holes. Top joints 40 and bottom joints 41 are formed of the solder of the invention.

Accordingly, the preferred embodiment of the present invention has been described. With the foregoing description In mind, however, it is understood that this description is made only by way of example, that the invention is not limited to the particular embodiments described herein, and that various rearrangements, modifications, and substitutions may be implemented without departing from the true spirit of the Invention as hereinafter claimed.

What is claimed is:

1. A ternary solder alloy which is lead free, of high strength and particularly well suited for microelectronic applications consisting essentially of tin, silver and bismuth with tin in a major proportion, bismuth in excess of 5 wt % and up to 25 wt % and silver in a range from about 2 wt % to less than 5% silver.

2. A ternary solder alloy as defined in claim 1 consisting essentially of tin in a range from about 70 wt % to less than 91 wt %, bismuth in a range from about 5 wt % to 25 wt % and silver in a range from 2 wt % to 5 wt %.

3. A ternary solder alloy as defined in claim 2 consisting essentially of about 6.1 wt % bismuth, 3.1 wt % silver balance tin.

4. A ternary solder alloy as defined in claim 2 consisting essentially of about 10-1 5 wt % bismuth, 3.3-3.5 wt % silver, balance tin and having a controlled liquidus temperature of between about 191° C. -201° C.

5. A microelectronic structure comprising at least two microelectronic components joined by means of a solder alloy with the solder alloy consisting essentially of tin, silver and bimuth with tin in a major proportion, bismuth in excess of 5 wt % and up to 25 wt % and silver in a range from about 2 wt % to less than 5 wt %.

6. A microelectronic structure as defined in claim 5 wherein said solder alloy consists essentially of from about 70 to less than 91 weight percent tin, from about 5 wt % to 25 wt % bismuth and from 2 wt % to 5 wt % silver.

7. A microelectronic structure as defined in claim 5 wherein said microelectronic components are selected from the group consisting of: chip carriers, IC chips and circuit boards.

8. A method of joining at least two microelectronic components to one another comprising the steps of connecting the components to be joined with a ternary solder alloy consisting essentially of a major proportion of tin, between about 5 to 25 wt % bismuth and 2 to 5 wt % silver.

9. A method as defined in claim 8 wherein said solder alloy consists essentially of from about 70 to less than 91 weight percent tin, from about 5 to 25 wt % bismuth and from 2 to.5 wt % silver.

10. A method as defined in claim 8 wherein said solder alloy consists essentially of about 10-1 5 wt % bismuth, 3.3-3.5 wt % silver, balance tin.

11. A solder paste comprising a flux, an organic vehicle and particles of metal having a composition consisting essentially of a major proportion by weight of tin, between about 5 to 25 wt % bismuth and from 2 to 5 wt % silver.

12. A solder paste as defined in claim 11 wherein said composition consists essentially of from about 70 to less than 91 weight percent tin, from about 5 to 25 wt % bismuth and from 2 to 5 wt % silver.

13. A process for producing circuit boards, comprising the steps of:
producing plated through holes in a circuit board;
inserting the pins of pin-in-hole components into the plated through holes;
producing a stationary wave of liquid solder consisting essentially of a major proportion of tin, between about 5 to 25 wt % bismuth and from 2 to 5 wt % silver;
moving the circuit board across the wave with the bottom of the circuit board in contact with the wave, thereby substantially filling the plated through holes with solder; and
cooling the circuit board to form solid solder joints.

14. A process for producing circuit boards comprising the steps of:
producing a substrate with multiple wiring layers including exposed metal pads on a surface;
forming a solder paste comprising a flux, an organic vehicle and particles of metal consisting essentially of a major proportion of tin, bismuth in excess of 5 wt % and up to 25 wt % and from 2 to 5 wt % silver;
depositing the solder paste upon said substrate;
placing terminals of a surface mount component onto corresponding pads of the substrate;
heating said solder paste to a temperature sufficient to reflow the solder paste to conned the component with the substrate; and
cooling to solidify the connections.
